(19) United States
(12) Patent Application Publication
(10) Pub. No.: US 2012/0234190 A1
(43) Pub. Date: Sep. 20, 2012

(54) REUSABLE PRINTING DEVICE

(76) Inventor: Yehuda Solomon, Rishon Le Zion (IL)

(21) Appl. No.: 13/049,951

(22) Filed: Mar. 17, 2011

(51) Int. Cl. B41C 3/00

(52) U.S. Cl. 101/401.1

(57) ABSTRACT

An apparatus for preparing a printing cylinder includes providing an image bearing printing surface comprising a plurality of cells; applying a filling material into the cells; fixing the filling material in a first group of cells in a first pattern; and removing the filling material from a second group of cells.

### CROSS REFERENCE TO RELATED APPLICATIONS

Reference is made to commonly-assigned copending U.S. patent application Ser. No. ______ (Attorney Docket No. K000109US01/NAB), filed herewith, entitled REUSABLE PRINTING DEVICE, by Solomon, the disclosure of which is incorporated herein.

### FIELD OF THE INVENTION

This invention relates in general to printing, and in particular to a re-usable printing surface having a plurality of cells.

### BACKGROUND OF THE INVENTION

In current printing technology the final image is conveyed to a substrate by transferring ink from an image bearing printing surface to the substrate. The image bearing surface generally picks up ink only on the ‘image’ areas, the areas that correspond on the substrate to be inked. The print on the substrate is produced by transferring ink directly or indirectly from an inked-up image bearing surface to the substrate. An example of this technology is a printing plate wherein certain areas of the plate are hydrophobic or hydrophilic.

In conventional printing systems, the image bearing surface picks up liquid or paste ink, typically from an ink reservoir. The means by which the surface transfers ink to the ‘image’ areas depends upon the particular technology. Printing plates will be used in flexography and offset lithography, whereas specially made cylinders are used in gravure printing. The ink is then transferred to another surface, be it the final product substrate, such as printed paper, or an intermediate medium such as a rubber blanket.

In digital printing systems, ink is transferred to the substrate in various ways for example, inkjet printing. Digital printing has an advantage over conventional print in its ability to handle variable information. This allows the printer to tailor each print differently. The main drawbacks of digital printing are that it is, in general, significantly more expensive and time consuming than conventional printing processes.

### SUMMARY OF THE INVENTION

Briefly, according to one aspect of the present invention an apparatus for preparing a printing cylinder includes providing an image bearing printing surface comprising a plurality of cells; applying a filling material into the cells; fixing the filling material in a first group of cells in a first pattern; and removing the filling material from a second group of cells.

The invention and its objects and advantages will become more apparent in the detailed description of the preferred embodiment presented below.

### BRIEF DESCRIPTION OF THE DRAWINGS

FIG. 1 is a schematic illustration of a printing block with plurality of printing cells;

FIG. 2a is a schematic illustration of blocked and empty printing cells;

FIG. 2b is a cross-section of several empty printing cells on the printing block surface;

FIG. 2c is a cross-section of several printing cells on the printing block surface wherein some of them are empty, fully filled, or partially filled;

FIG. 3 is a schematic illustration of a printing block imaging device consisting of an imaging system and a cylinder made printing block the imaging system is adapted to adjust the printing cells content; and

FIG. 4 is a schematic illustration of an inkjet system adapted to fill the printing cells with blocking material.

### DETAILED DESCRIPTION OF THE INVENTION

The present invention describes a direct printing device containing a surface of printing cells. The printing cells can be filled by selective control thus allowing forming an image to be printed on a substrate. A previously formed image can be erased from printing cells surface and modified forming another image by suitable imaging means.

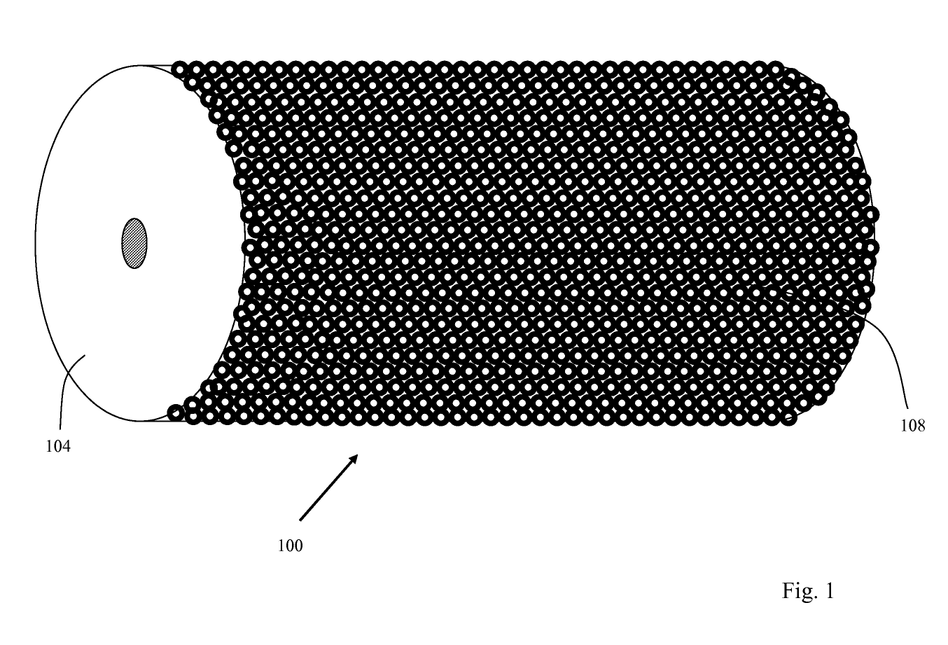

FIG. 1 shows a printing cylinder 100. The printing cylinder 100 contains a printing block 104. The printing block 104 is covered with an image bearing surface 108, containing plurality of printing cells. The printing cells are in a form of micro-cavities of holes spread on surface 108, the printing cells are geometrically arranged for printing. The printing block 104 can be round as is depicted in FIG. 1 or flat (not shown). The printing block 104 can be made from flexible material. Additionally the round printing block 104 in FIG. 1 can rotated during imaging or can be fixed into a single position during imaging.

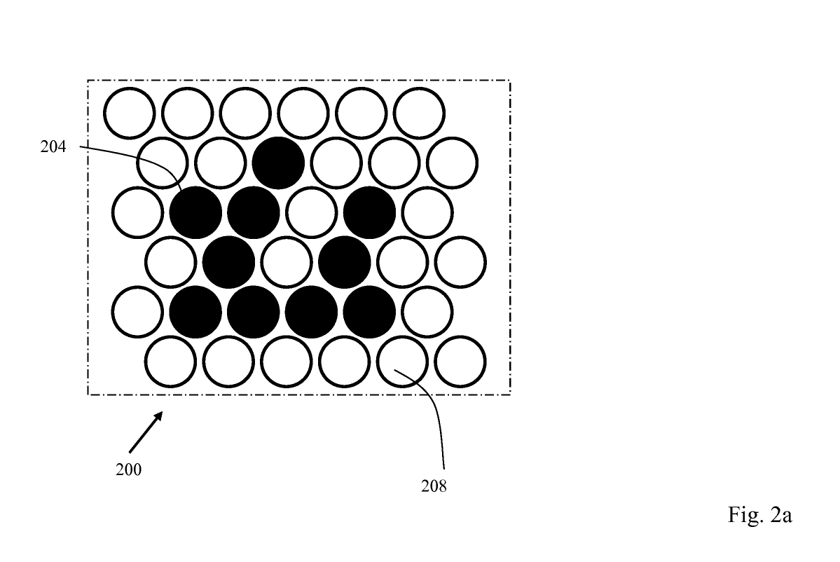

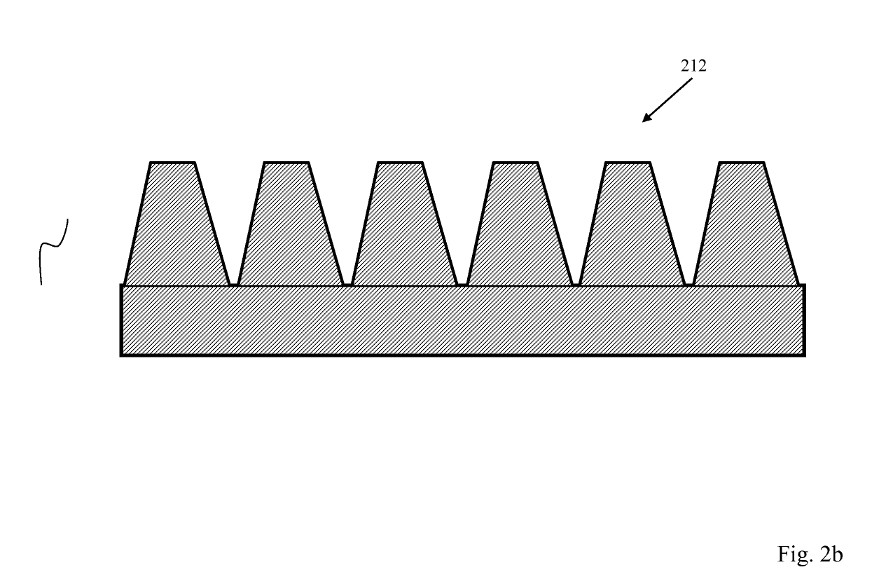

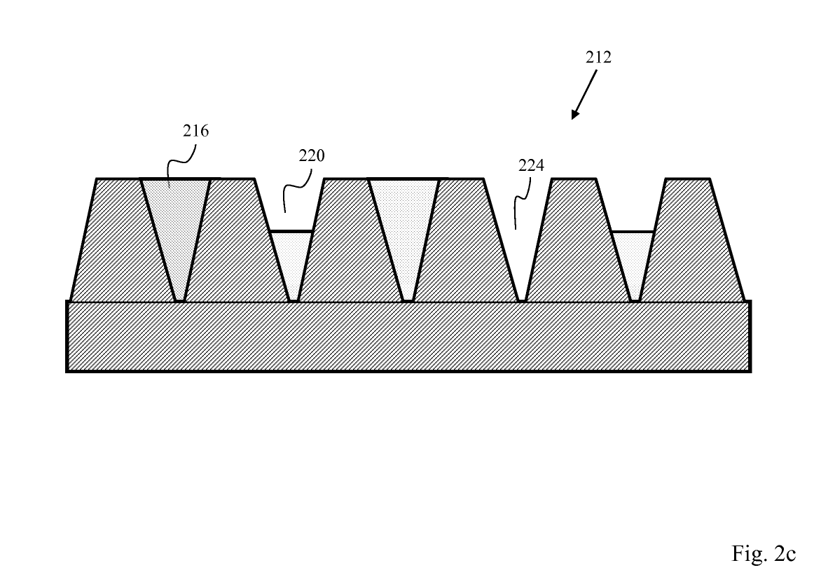

FIG. 2a, depicts an illustration of printing cells 200 representing a segment of printing cells out of image bearing surface 108. The printing cells 200 are divided into two groups of cells, fully filled cells 204 and non-blocked or empty cells 208. The division of cells into two groups forms an image and transforms printing cells surface into an image bearing surface. The image bearing surface 108 when applied with ink and pressed on a substrate (not shown) will cause the image represented by printing cells 204 and 208 to be printed on the substrate.

In another arrangement, more than two groups (204, 208) can be formed, where each of the additional groups of cells represent filling of printing cells 200 in levels that may range from non empty to not fully filled printing cells.

FIG. 2b shows a cross-section of several empty printing cells on the printing block surface 212. FIG. 2c shows the filling level of the printing cells, for example printing cell 216 is fully filled, printing cell 220 is partially filled and printing cell 224 is not filled at all. Similar arrangements can be made by adding additional filling levels. The impact on the printing substrate of the printing cells with various filling will be different and distinct from each other.

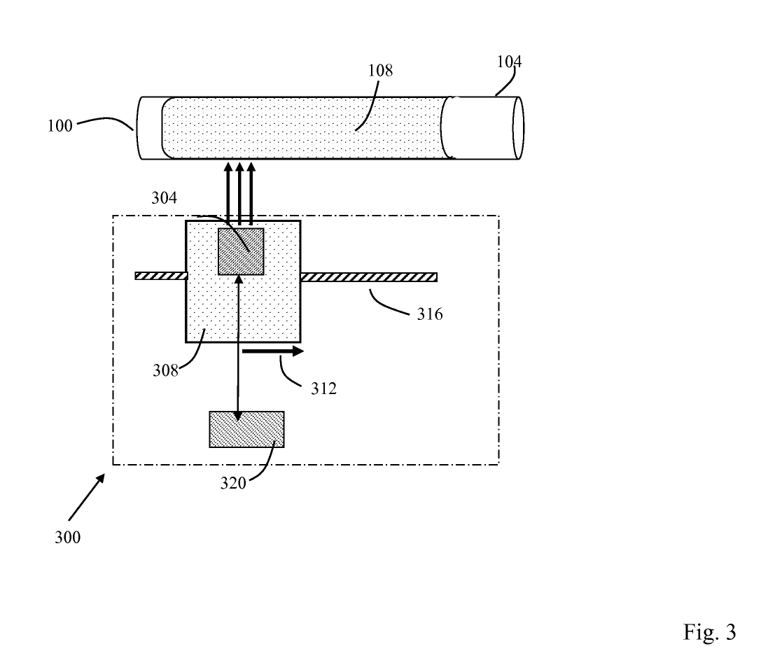

In order to form an image on the image bearing surface 108, a filling material is applied one the entire surface 108. The filling material can be a photopolymer that will be cured by ultra violet (UV) light, or the filling material can be a liquid polymer to be solidified by cooling means. Another filling material can a polymer solution that solidifies by vaporization of the solvent, when laser means or other thermal sources area applied. All the printing cells (204 and 208) are filled with the printing material. The filling material can be applied for example by immersing the entire surface 108 in a filling material reservoir (not shown). The next step is to fix the filling material residing in a selected group of printing cells for example printing cells 204 and removing the filling material (which is not fixed) from printing cells 208, the removal of the filling material can be performed by an printing block imaging device 300 (shown in FIG. 3), described further in this document.

Fixing of the filling material can be achieved by applying UV (ultra violet) light in printing cells 204. Another alternative for fixing the filling material in cells 204 is by applying heat on the filling material in the first group in printing cells 204. The fixing method depends on the characteristics of the chosen filling material.

At this stage the image bearing surface 108 represent an image which is ready to be mounted on a printing device (not shown) for printing. The imaging device 300 can integrated into a printing device as a pre-printing step or alternatively can be a standalone system detached from a printing device. The image is formed according to a previously prepared halftone image. The halftone image is typically prepared by a digital front end (DFE) (not shown) server such as Kodak Prinergy, the DFE is capable to process a printing job received in a page description language (PDL) format and rasterizing it into a halftone image or a plurality of halftone images that represent the entire print job, ready for imaging.

In order to perform printing, the printing block 104 is mounted on a printing device. Printing of the halftone image is initiated, the printing can be performed directly from the printing block 104 to a substrate, or alternatively via an intermediate blanket to the substrate. After printing is completed the printing block 104 is unloaded from the printing device. The printing block 104 is loaded on an imaging device 300 shown in FIG. 3, for removal of the filling material from cells 204. This process will enable reuse of printing block 104 for subsequent printing of new printing jobs. The cleaning of cells 204 or is performed by imaging device 300.

The imaging device 300 includes a laser imaging head 304 mounted on carriage 308 in direction 312, parallel to printing cylinder 100. The carriage movement is coordinated by screw 316. The laser imaging head 304 emits laser energy pointed on the cells 204 (filled with filling material). The information which cells are filled with a filling material is provided to imaging head 304 by micro-controller 320. Micro-controller 320 receives the information on cells 204 from the previously prepared halftone image that had been used to form an image on printing block 104. The applied laser energy from imaging head 304 is adapted to dissolve the filling material from cells 204.

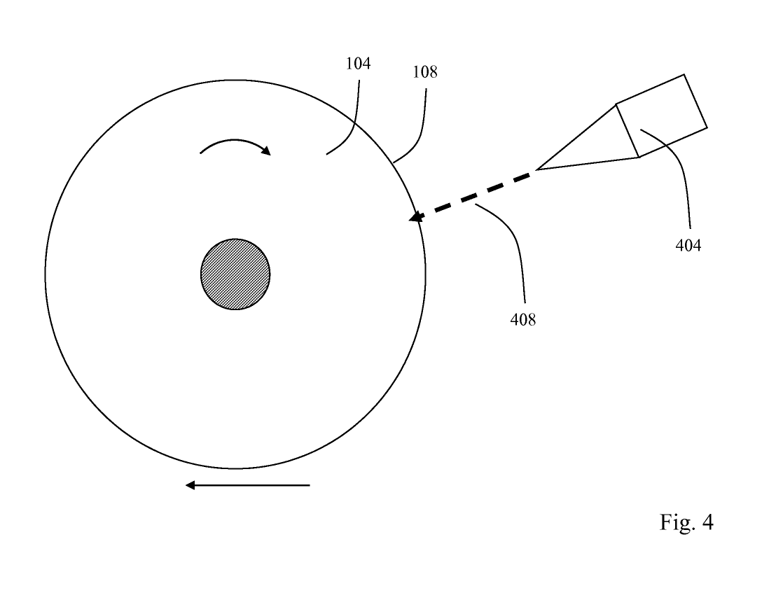

Another embodiment that is used to fill cells 204 with filling material is described in FIG. 4. FIG. 4 shows an inkjet head 404 configured to apply filling material via inkjet means only on cells 204 of surface 108. In this embodiment there is no need to fill the entire cells of surface 108, but only the selected cells 204 defined by the halftone image are injected by inkjet head 404 with filling material 408. The fixing of filling material is preformed selectively to cells 204.

In certain embodiments cells 204 will serve as printing cells and cells 208 as non printing cells, in other embodiments cells 208 will be printing cells whereas cells 204 will not print.

The invention has been described in detail with particular reference to certain preferred embodiments thereof, but it will be understood that variations and modifications can be effected within the scope of the invention.

### PARTS LIST

100 printing cylinder
104 printing block
108 image bearing surface
200 printing cells
204 fully filled cells
208 empty cells
212 printing block surface
216 fully filled printing cell
220 partially filled printing cell
224 empty printing cell
300 imaging device
304 imaging head
308 carriage
312 carriage direction
316 screw
320 micro-controller
404 inkjet head
408 injected filling material

1. A printing apparatus comprising:
an image printing surface;
a plurality of cells on the printing surface;
a device for filling the cells with a filling material;
a fixing element for fixing the filling material in a first group of cells in at least a first pattern; and
an imaging element for removing the filling material from a second group of cells.

2. A printing apparatus according to claim 1 wherein the filling device is an inkjet element.

3. The printing apparatus according to claim 1 wherein the printing surface comprises a cylinder.

4. The printing apparatus according to claim 1 wherein the printing surface is a flexographic plate.

5. The printing apparatus according to claim 1 wherein the plurality of cells is arranged in a geometric pattern.

6. The printing apparatus according to claim 1 wherein the first pattern is a halftone image.

7. The printing apparatus according to claim 1 wherein the fixing element applies ultra violet light to the filling material.

8. The printing apparatus according to claim 1 wherein the fixing element applies heat to the filling material.

9. The printing apparatus according to claim 1 wherein the imaging device is a laser.

10. The printing apparatus according to claim 1 wherein the filling material is selected from a group consisting of a photopolymer, a liquid polymer, a polymer solution, or a combination thereof

11. The printing apparatus according to claim 1 wherein the filling materials only partially fill the cells.

12. The printing apparatus according to claim 1 wherein the filling material in a portion of the first group of cells is partially fixed.
